(19) United States
(12) Patent Application Publication
(10) Pub. No.: US 2013/0293381 A1
(43) Pub. Date: Nov. 7, 2013

(54) Anti-Theft Basketball and System

(71) Applicant: Kenneth Cigril Washington, Greensboro, NC (US)

(72) Inventor: Kenneth Cigril Washington, Greensboro, NC (US)

(21) Appl. No.: 13/888,732

(22) Filed: May 7, 2013

Related U.S. Application Data
(60) Provisional application No. 61/743,719, filed on Sep. 10, 2012.
(60) Provisional application No. 61/688,004, filed on May 7, 2012.

(51) Int. Cl. G08B 13/24; A63B 43/00

(52) U.S. Cl. CPC G08B 13/2462; A63B 43/004
USPC 340/568.6; 473/570

(57) ABSTRACT

An anti-theft basketball including an identification device that triggers an alert if such basketball passes a boundary including a reader that interrogates the identification device. The basketball incorporates such identification device in a manner that does not affect the integrity, size, shape, or bounce of the basketball, such as on top of, under, or within the cover of the basketball or its inflatable core.

This application claims the benefit of U.S. Provisional Application No. 61/688,004 filed on May 7, 2012 and U.S. Provisional Application No. 61/743,719, filed Sep. 10, 2012, the disclosures of which are expressly incorporated herein by reference.

### BACKGROUND

The present invention is directed towards an anti-theft basketball and system for using the same. Many gymnasiums, such as those operated by athletic training facilities, fitness facilities, community centers, schools and the like experience loss of basketballs each year. The loss is typically due to patrons leaving the gymnasium with the balls, either intentionally or inadvertently. It is very costly for the operators of such facilities to replace the basketballs each year.

The present invention overcomes this issue by providing an anti-theft basketball including a tracking device that triggers an alert if such basketball passes a boundary including a sensor that detects the tracking device. The basketball incorporates such tracking device in a manner that does not affect the integrity, size, weight, or bounce of the basketball.

### BRIEF SUMMARY OF THE INVENTION

A ball loss prevention system including a ball having a cover, an inflatable core, and a wireless identification device that is integrated with the ball in a manner that does not substantially affect the size, weight, and bounce of the ball. The wireless identification device may be affixed to the ball on its cover, within the cover, under the cover, on the core, or within the core. The wireless identification device stores data specific to the basketball, such as identifying indicia, date of manufacture, date of first use, and designated location. The wireless identification device may be a radio frequency identification (RFID) device that is configured to modulate and demodulate a radio-frequency signal, and may be a passive RFID device.

The system further includes a reader that initiates an alert when it reads data transmitted from the wireless identification device. The alert may be an audible alarm and/or a notification that is transmitted to an operator computer. In an embodiment of the present invention, the reader is disposed within a security bar. In a further embodiment, the reader is disposed at a location predetermined by an operator as a boundary for which the ball should not pass.

### BRIEF DESCRIPTION OF THE DRAWINGS

FIG. 1 is a perspective view of a basketball.

FIG. 2 depicts a cross-section of the inside of the basketball of FIG. 1.

FIG. 3 depicts a basketball with a RFID tag in accordance with an embodiment of the invention.

FIG. 4 depicts a pair of RFID reader panels and a basketball in accordance with an embodiment of the present invention.

### DETAILED DESCRIPTION OF THE INVENTION

The present invention is directed towards anti-theft basketball including a tracking device that triggers an alert if such basketball passes a boundary including a sensor that detects the tracking device.

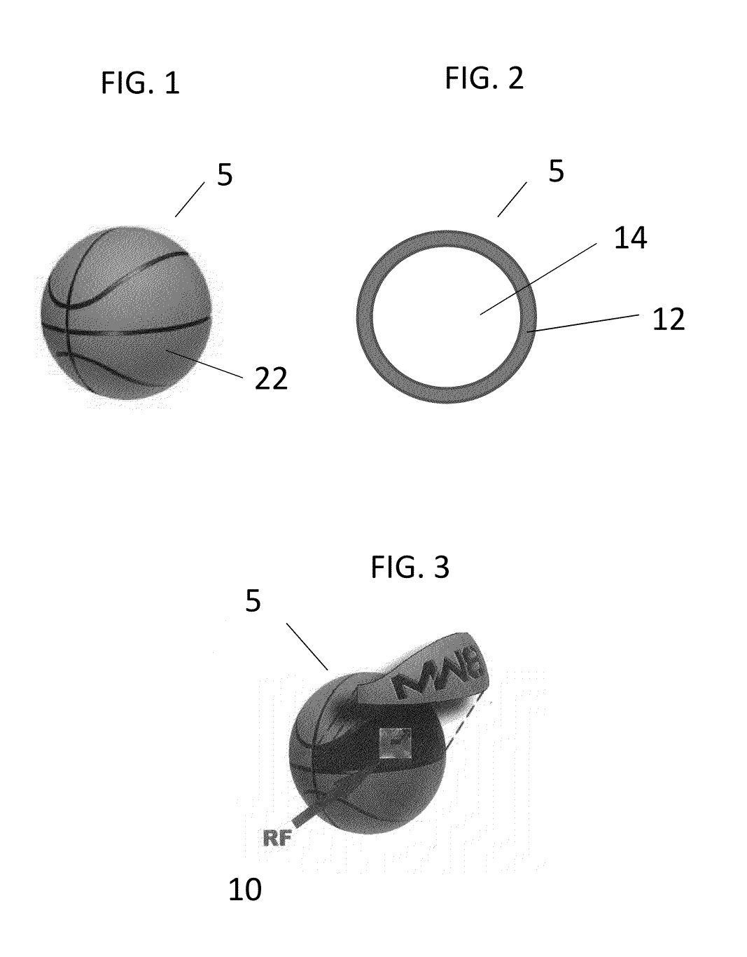

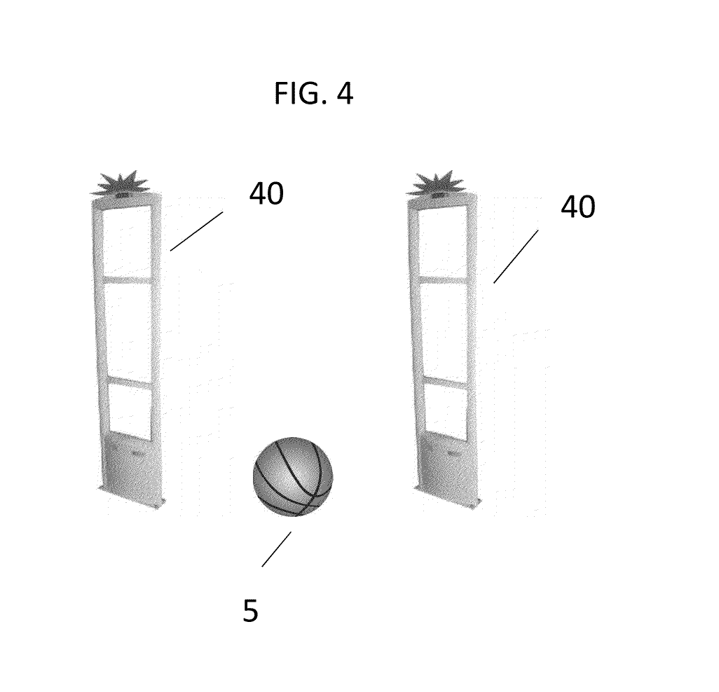

As shown in FIG. 1, a typical basketball 5 is spherical in shape and is inflated. Basketballs usually range in size from about 28.5-30 in (72-76 cm) in circumference, and in weight from about 18-22 oz (510-624 g). The cover (also referred to as the casing) 12 of the ball 5 is typically made of leather, rubber, composition, or synthetic materials, although some league rules specify use of only a particular type of cover material. The cover 12 of the ball 5 is typically characterized by a number of panels 22 with a pebbled (small bumps) surface that are outlined by smooth grooves. A typical basketball may comprise 8, 10, 12, 14, or 16 panels 22.

As shown in FIG. 2, a bladder (also referred to as a core) 14 is disposed inside the cover 12 and holds the air that inflates the ball 5. The amount of inflation is based on the desired height of the ball's 5 bounce. Ideally, the ball 5 must be inflated to a pressure sufficient to make it rebound to a height (measured to the top of the ball) of 49-54 in (1.2-1.4 m) when it is dropped on a solid wooden floor from a starting height of 6 ft (1.80 m) measured from the bottom of the ball 5.

As shown in FIG. 3, in an embodiment of the present invention, a wireless identification device 10 that is capable of storing and transmitting data, such as a radio frequency identification (RFID) tag 10, is integrated with the basketball 5 without adversely affecting the integrity, weight, size, or bounce of the basketball 5. The RFID tag 10 may be one known in the art that includes an integrated circuit for storing and processing information and modulating and demodulating a radio-frequency (RF) signal. Known frequencies for such RFID tags 10 are about 8.2 MHZ, about 10.2 MHZ, and about 4.74 MHZ, known bandwidths for such RFID tags 10 are about 7.7 to about 8.7 MHZ, and known scan rates for such RFID tags 10 are about 158 HZ, about 164 HZ, about 170 HZ, and about 176 HZ; however, it is noted that the RFID tag 10 of the present invention is not limited to such particular specifications.

The RFID tag 10 may be an active RFID tag, which contains a battery and can transmit signals autonomously, a passive RFID tag, which has no battery and requires an external source to provoke signal transmission, or a battery assisted passive (BAP) tag, which requires an external source of power. In some embodiments of the present invention, the RFID tag 10 is a passive tag and the external source that provokes the signal transmission is a RFID tag reader, as explained in more detail below.

The RFID tag 10 is integrated with the basketball 5 in such a manner that the basketball 5 remains substantially spherical without any adverse effect on its bounce, size, or weight that would render it a non-regulation ball under most organized league rules. Examples of where the RFID tag 10 may be applied include under the cover 12 but on top of the bladder 14, within the cover 12, on top of the cover 12, within the wall of the bladder 14, and/or in the bladder 14. The RFID tag 10 is adhered to the ball 5 using known adhesives. In some embodiments, the size of the RFID tag 10 ranges from about 3×3 cm to about 9×7 cm. It is noted, however, that the present invention is not limited to a particular size of the RFID tag 10 so long as the size is suitable for being integrated with the basketball 5 without any adverse effect on size, weight, or bounce.

In an embodiment of the present invention, the RFID tag 10 is encoded with unique identifying indicia for the basketball 5 with which it is associated, such indicia being composed of letters, numbers, characters and/or a combination thereof. Such information on the tag 10 may further include, for example, the size of the basketball, type of material of which it is made, its date of manufacture, its date of first use, its designated location, and other ball-specific information.

At any time after the tags 10 have been encoded with the basketball 5 specific information, RFID tag readers may be utilized to interrogate the RFID tags 10 and read the data stored on them. In an embodiment of the present invention, the readers may be housed in or integrated with security bars 40, such as known security bars that are utilized in retail stores and the like. The security bar 40 may be disposed, for example, near the exit doors of a gymnasium where the ball 5 is intended to be used. When a basketball 5 including a tag 10 is within a predetermined range of the reader housed within the security bar 40, the reader is able to interrogate the tag 10, read the data transmitted from the tag 10, and trigger an alert. For example, the security bar 40 may comprise means for sounding an audible alarm. Additionally, the reader in the security bar 40 may automatically transmit an alert to the operator's computer indicating that the detected basketball 5 is within the predetermined range of the security bar 40. Such alarms and alerts may be used to remind the person associated with the ball 5 that the ball 5 should not leave that designated area and to alert operator personnel to address any person attempting to leave the designated area with the ball 5.

Based on the foregoing, the present invention provides an anti-theft basketball including an identification device that triggers an alert if such basketball passes a boundary including a reader that interrogates the identification device. The basketball is integrated with such identification device in a manner that does not affect the integrity or bounce of the basketball.

Certain modifications and improvements will occur to those skilled in the art upon a reading of the forgoing description. For example, it should be understood that the present invention is not limited to just basketballs. Rather the RFID tag and corresponding reader can be used in conjunction with any type of apparatus or ball that is desired to be maintained within a designated location. Also, the present invention is not limited to housing the RFID tag reader within a security bar. Rather, the RFID tag reader can be disposed in any suitable housing or structure. It should be further understood that the operator's computer for facilitating the system described herein can be any type of computing device having a processor including without limitation desktop computers, laptops, personal digital assistants, cellular phones, tablets, smart televisions, and the like. All such modifications and improvements of the present invention have been deleted herein for the sake of conciseness and readability.

What is claimed is:

1. A ball comprising:
a cover;
an inflatable core; and
a wireless identification device that is integrated with the ball in a manner that does not substantially affect the size, weight, and bounce of the ball.

2. The ball of claim 1 wherein the ball is a basketball.

3. The ball of claim 1, wherein the wireless identification device stores data specific to the basketball.

4. The ball of claim 1 wherein the wireless identification device is a radio frequency identification (RFID) device that is configured to modulate and demodulate a radio-frequency signal.

5. The ball of claim 4 wherein the RFID device is a passive RFID device.

6. The ball of claim 5 wherein the data is selected from the group consisting of identifying indicia, date of manufacture, date of first use, and designated location.

7. The ball of claim 5 wherein the wireless identification device is configured to transmit the data to a reader.

8. The ball of claim 1 wherein the wireless identification device is affixed to the ball in a location selected from the group consisting of on the cover, within the cover, under the cover, on the core, and within the core.

9. The ball of claim 1, wherein the wireless identification device is configured to be interrogated by a reader that initiates an alert upon such interrogation.

10. A ball loss prevention system comprising:
a ball comprising:
a cover;
an inflatable core; and
a wireless identification device that is integrated with the ball in a manner that does not substantially affect the size, weight, and bounce of the ball; and
a reader that reads data from the wireless identification device;
wherein when the reader reads data from the wireless identification device, the reader initiates an alert.

11. The system of claim 10, wherein the wireless identification device stores data specific to the basketball.

12. The system of claim 10 wherein the wireless identification device is a radio frequency identification (RFID) device that is configured to modulate and demodulate a radio-frequency signal.

13. The system of claim 12 wherein the RFID device is a passive RFID device.

14. The system of claim 10 wherein the data is selected from the group consisting of identifying indicia, date of manufacture, date of first use, and designated location.

15. The system of claim 10 wherein the wireless identification device is configured to transmit the data to the reader.

16. The system of claim 10 wherein the wireless identification device is affixed to the ball in a location selected from the group consisting of on the cover, within the cover, under the cover, on the core, and within the core.

17. The system of claim 10, wherein the alert is an audible alarm.

18. The system of claim 10, wherein the alert is a notification transmitted to an operator computer.

19. The system of claim 10 wherein the reader is disposed within a security bar.

20. The system of claim 10 wherein the reader is disposed at a location predetermined by an operator as a boundary for which the ball should not pass.
